(19) United States
(12) Patent Application Publication
(10) Pub. No.: US 2008/0211407 A1
(43) Pub. Date: Sep. 4, 2008

(54) Plasma display panel and method of forming barrier ribs of the plasma display panel

(76) Inventor: Jung-Suk Song, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/896,697

(22) Filed: Sep. 5, 2007

(30) Foreign Application Priority Data
Sep. 20, 2006 (KR) 10-2006-0091107

(51) Int. Cl. H01J 17/49; H01J 9/00

(52) U.S. Cl. 313/582; 445/24

(57) ABSTRACT

A method of forming barrier ribs of a plasma display panel includes providing a barrier rib layer on a substrate and selectively removing portions of the barrier rib layer to form a barrier rib structure defining a plurality of first and second discharge cells, at least one barrier rib of the barrier rib structure having a horizontal cross-section that is asymmetric along a center axis thereof, the first and second discharge cells having different internal surface areas.

### BACKGROUND OF THE INVENTION

1. Field of the Art

Embodiments relate to a plasma display panel (PDP) and a method of forming barrier ribs of the PDP.

2. Description of the Related Art

Generally, plasma display panels (PDPs) are display apparatuses that display predetermined images by exciting a phosphor material using ultraviolet rays generated from a gas discharge. PDPs have received attention as next generation thin display apparatuses due to their high resolution and potentially large screen sizes.

PDPs may be classified according to which driving method is used, e.g., direct current (DC) PDPs, alternating current (AC) PDPs, and hybrid PDPs. The DC and AC PDPs may be further classified according to their discharge structure, e.g., facing discharge PDPs or surface discharge PDPs. Recently, AC PDPs have gained popularity.

In conventional PDPs, barrier ribs may be formed by sandblasting. However, in mass-production, sandblasting may result in a lot of opening failures in the barrier ribs. Therefore, as a method of reducing opening failures in the barrier ribs, an etching method may be applied in the formation of PDPs. The etching method may pattern barrier ribs by spraying an etching solution where the discharge cells are to be formed.

In PDPs, color images may be displayed by having red, green, and blue discharge cells which respectively have red, green, and blue phosphor layers therein. However, the red, green, and blue phosphor materials may contribute to the display brightness, increase in luminous efficiency, and/or improve color temperature by differing degrees.

Conventional PDP technology related to uniform barrier rib structure has not addressed this problem associated with performance and behavior differences between different phosphor layers.

### SUMMARY

Embodiments are therefore directed to a plasma display panel (PDP) and a method of forming barrier ribs of a PDP, which substantially overcome one or more of the problems due to the limitations and disadvantages of the related art.

It is therefore a feature of an embodiment of the present invention to provide a PDP and method of making barrier ribs for the PDP that reduces opening failures of barrier ribs.

It is therefore another feature of an embodiment to provide a PDP and method of making barrier ribs for the PDP that includes different discharge spaces within the discharge cells.

It is therefore another feature of an embodiment to provide a PDP and method of making barrier ribs for the PDP that has barrier ribs of different thicknesses for the different discharge spaces.

It is therefore another feature of an embodiment to provide a PDP and method of making barrier ribs for the PDP that has different phosphor materials in the different discharge spaces.

It is therefore yet another feature of an embodiment to provide a PDP that has increased brightness.

It is therefore yet another feature of an embodiment to provide a PDP that has an increased luminous efficiency.

It is therefore yet another feature of an embodiment of the present invention to provide a PDP that has improved color temperature.

At least one of the above and other features and advantages may be realized by providing a method of forming barrier ribs of a PDP, including providing a barrier rib layer on a substrate; and selectively removing portions of the barrier rib layer to form a barrier rib structure defining a plurality of first and second discharge cells, at least one barrier rib of the barrier rib structure having a horizontal cross-section that is asymmetric along a center axis thereof, the first and second discharge cells having different internal surface areas.

Providing the barrier rib layer may include forming a first barrier rib layer and a second barrier rib layer on the substrate, the first and second barrier rib layers being adjacent on the substrate and having different etch speeds. Selectively removing may include providing an etch mask to expose a predetermined region of the first barrier rib layer and a predetermined region of the second barrier rib layer, and etching the exposed predetermined regions of the first and second barrier rib layers using the etch mask.

The first barrier rib layer may have a first etching speed with respect to an etching solution, and the second barrier rib layer may have a second etching speed, which may be slower than the first etching speed, with respect to the etching solution.

Forming the first barrier rib layer and the second barrier rib layer may include providing the first barrier rib layer on the substrate where the first discharge cells are to be formed and providing the second barrier rib layer on the substrate where the second discharge cells are to be formed. Forming the first barrier rib layer may further include providing a third barrier rib layer on the first barrier rib layer.

The first and second discharge cells may be provided with different phosphor materials. The different phosphor materials may produce different colors. There may be twice as many first discharge cells as second discharge cells, and the at least one barrier rib may be between one of the first discharge cells and one of the second discharge cells. The at least one barrier rib may define adjacent discharge cells having different widths. An internal surface area of the first discharge cells may be greater than that of the second discharge cells.

Selectively removing may include providing a first etch mask on the barrier rib layer to expose a first predetermined region of the barrier rib layer where the first discharge cells are to be formed, etching the exposed barrier rib layer using a first etching solution that has a first etching speed with respect to the barrier rib layer, providing a second etch mask on the barrier rib layer to expose a second predetermined region of the barrier rib layer where the second discharge cells are to be formed, etching the exposed barrier rib layer using a second etching solution that has a second etching speed, which is different from the first etching speed, with respect to the barrier rib layer. The second etching speed may be slower than the first etching speed.

At least one of the above and other features and advantages may be realized by providing a PDP, including a rear substrate, a front substrate a predetermined distance apart from the rear substrate, and a barrier rib structure between the front and rear substrates, the barrier rib structure defining a plurality of first and second discharge cells, at least one barrier rib of the barrier rib structure having a horizontal cross-section that is asymmetric along a center axis thereof, the first and second discharge cells having different internal surface areas.

The at least one barrier rib may include a first material on the substrate and a second material on the substrate, the second material abutting the first material, a first sidewall of the first material having a different slope than a second sidewall of the second material. The at least one barrier rib may further include a third material on the first material, the second material abutting the third material. The second and third materials may be the same. A third sidewall of the third material may have a different slope than the first sidewall.

The at least one barrier rib may be made of a single material.

The PDP may include a first phosphor material in the first discharge cells, and a second phosphor material in the second discharge cells, the second phosphor material being different from the first phosphor material. The first and second phosphor materials may produce different colors.

The PDP may have twice as many first discharge cells as second discharge cells, and the at least one barrier rib may be between one of the first discharge cells and one of the second discharge cells.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIGS. 1 through 4 illustrate perspective views of stages in a method of manufacturing barrier ribs of a plasma display panel according to an embodiment;

FIGS. 5A through 6B illustrate cross-sectional views of a barrier rib illustrated in FIG. 4, taken along lines 5A-5A′, 5B-5B′, 6A-6A′, and 6B-6B′, respectively;

FIGS. 7 through 10 illustrate perspective views of stages in a method of manufacturing barrier ribs according to an embodiment;

FIGS. 11A through 12B illustrate cross-sectional views of a barrier rib illustrated in FIG. 10, taken along lines 11A-11A′, 11B-11B′, 12A-12A′, and 12B-12B′, respectively;

FIGS. 13 through 17 illustrate perspective views of stages in a method of manufacturing barrier ribs according to an embodiment;

FIG. 18 illustrates an exploded perspective view of a plasma display panel according to an embodiment;

FIGS. 19 through 21 illustrate cross-sectional views of the plasma display panel illustrated in FIG. 18, taken along lines 19-19′, 20-20′, and 21-21′, respectively;

FIG. 22 illustrates an exploded perspective view of a plasma display panel according to an embodiment; and

FIGS. 23 through 25 illustrate cross-sectional views of the plasma display panel illustrated in FIG. 22, taken along lines 23-23′, 24-24′, and 25-25′, respectively.

### DETAILED DESCRIPTION OF THE INVENTION

Korean Patent Application No. 10-2006-0091107, filed on Sep. 20, 2006, in the Korean Intellectual Property Office, and entitled: “Plasma Display Panel and Method of Forming Barrier Ribs of the Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

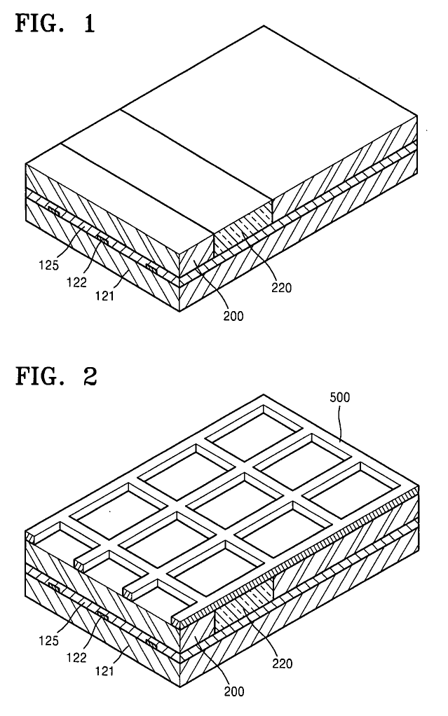

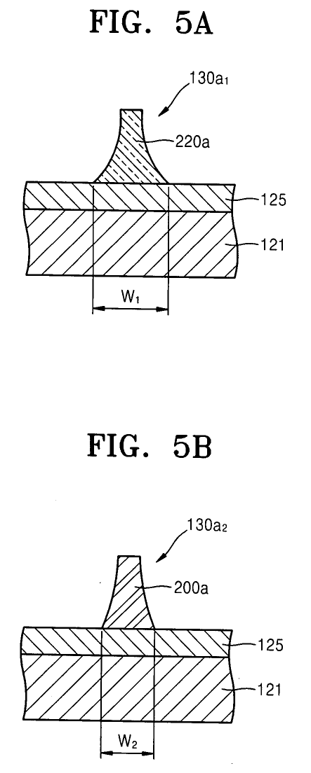

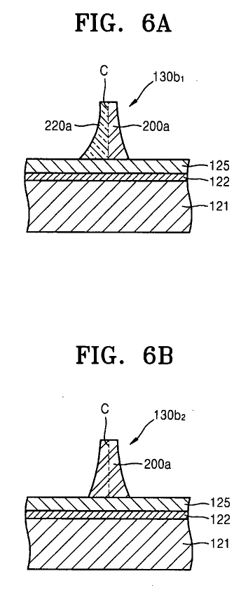

FIGS. 1 through 4 illustrate perspective views of stages in a method of manufacturing barrier ribs of a plasma display panel (PDP) according to an embodiment of the present invention. FIGS. 5A through 6B illustrate cross-sectional views of a barrier rib illustrated in FIG. 4.

Referring to FIG. 1, address electrodes 122 may be on a rear substrate 121, and a lower dielectric layer 125 may cover the address electrodes 122. The rear substrate 121 may include a first barrier rib layer 200 and a second barrier rib layer 220. More specifically, the first barrier rib layer 200 may be on a predetermined region of the rear substrate 121 adjacent where green or blue discharge cells are to be formed. Green discharge cells may greatly contribute to the increase in brightness and luminous efficiency of a PDP, while blue discharge cells may greatly contribute to the improvement of color temperature. The second barrier rib layer 220 may be on another predetermined region of the rear substrate 121 adjacent where red discharge cells are to be formed.

The first barrier rib layer 200 may include about 71.01% of powder composed of about 37.4% ZnO, 13.5% BaO, 23.7% B₂O₃, 8.4% P₂O₅, 1.0% Li₂O, 1.0% Na₂O, 5.0% Al₂O₃, and 10.0% ZnO, with about 2.01% C₁₀H₁₈O and 0.81% butyl carbitol acetate as solvents. An additive may provide the remaining amount. The second barrier rib layer 220 may include about 71.91% of powder composed of about 30∫50% ZnO, 20-35% BaO, 20-40% B₂O₃, 5-20% P₂O₅, 1-5% Li₂O, 1-10% Mn₂O₃, 1-5% Cr₂O₃, 3.0% Al₂O₃, and 4.0% ZnO, with about 2.01% C₁₀H₁₈O and 0.81% butyl carbitol acetate as solvents. An additive may provide the remaining amount. The additive may be a ceramic powder, a thennoplastic resin, or a plasticizer. The ceramic powder is used for the purpose of maintaining shape and can be used by combining one or two or more materials selected from the group consisting of alumina, zirconia, zircon, titania, cordierite, mullite, silica, willemite, tin oxide, and zinc oxide. The thermoplastic resin is used for the purpose of increasing film strength after drying and providing flexibility and can be, for example, poly(butyl methacrylate)(PBMA), poly vinylbutyral, poly methyl methacrylate, poly ethylmethacrylate, or ethylcellulose. The plasticizer is used for the purpose of controlling drying speed and providing flexibility to the dried film and can be butylbenzyl phthalate, di-octylphthalate, diisooctylphthalate, di-caprylphthalate, di-butylphthalate. Percentages in the above figures are percent by weight.

The first barrier rib layer 200 and the second barrier rib layer 220 may be provided on the rear substrate 121, e.g., by laminating a film that may include the first barrier rib layer 200 and the second barrier rib layer 220 from a roll of lamination. Alternatively, the first barrier rib layer 200 may be formed by coating a paste composition that constitutes the first barrier rib layer 200 onto a predetermined region of the rear substrate 121 and firing the paste composition. The second barrier rib layer 220 may be formed by coating a paste composition that constitutes the second barrier rib layer 220 on another predetermined region of the rear substrate 121 and firing the paste composition. However, the method of forming the first barrier rib layer 200 and the second barrier rib layer 220 according to the present invention is not limited to the above methods, but may be performed by using various methods.

Referring to FIG. 2, an etch mask layer 500 may be on the rear substrate 121 on which the first barrier rib layer 200 and the second barrier rib layer 220 have been formed. After a layer for forming an etch mask has been formed on the first and second barrier rib layers 200, 220, a photoresist layer (not shown) may be formed on this layer. A photoresist pattern layer may be formed by exposing and developing the photoresist layer using a photomask. The etch mask layer 500 may then be formed by etching the layer for forming an etch mask using the photoresist pattern. Alternatively, the photoresist pattern layer may be used as the etch mask layer 500 directly by omitting the formation of the etch mask layer.

FIG. 2 illustrates the etch mask layer 500 having a matrix type shape, but the present invention is not limited thereto. That is, the etch mask layer 500 may have various shapes according to the shape of the barrier ribs, e.g., a double barrier rib shape, or a striped rib shape.

The etch mask layer 500 may be formed so as to expose a predetermined region of the first and second barrier rib layers 200 and 220 where discharge cells are to be formed, and to protect the remaining region of the first and second barrier rib layers 200, 220 where barrier ribs are to be formed.

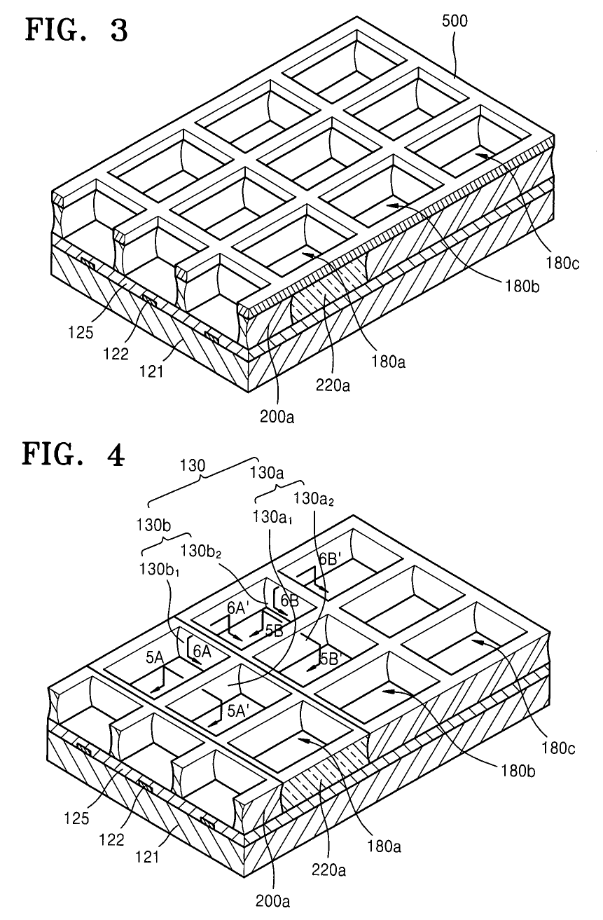

Referring to FIG. 3, the first and second barrier rib layers 200 and 220 may be removed, e.g., etched, in order to expose the lower dielectric layer 125 under first and second barrier rib layers 200a and 220a using the etch mask layer 500. A chemical etching method may be used in which an etching solution may be uniformly sprayed onto the components attached to the rear substrate 121. The etching solution may be, e.g., HNO₃. The chemical etching method may be, e.g., an isotropic etching method. Therefore, the etching solution may penetrate the first and second barrier rib layers 200a and 220a in all directions. Accordingly, the first and second barrier rib layers 200a and 220a formed by the chemical etching method may have curved sidewalls.

The first barrier rib layer 200a may have a first etching speed with respect to the particular etching solution. The second barrier rib layer 220a may have a second etching speed, which may be slower than the first etching speed, with respect to the etching solution. Accordingly, the first barrier rib layer 200a may be etched more than the second barrier rib layer 220a during the same etching period.

Referring to FIG. 4, the etch mask layer 500 may be removed from the resultant product of FIG. 3, to reveal a barrier rib 130 having a matrix type shape. The barrier rib 130 may include a plurality of horizontal barrier ribs 130a and a plurality of vertical barrier ribs 130b.

FIGS. 5A and 5B illustrate cross-sectional views of the horizontal barrier ribs 130a taken along lines 5A-5A′ and 5B-5B′, respectively, in FIG. 4. Referring to FIG. 5A, a first horizontal barrier rib 130a₁, that may define red discharge cells 180a, may be formed by the second barrier rib layer 220a with a lower width of W₁. Referring to FIG. 5B, a second horizontal barrier rib 130a₂, that may define green discharge cells 180b and blue discharge cells 180c, may be formed by the first barrier rib layer 200a with a lower width of W₂, which may be narrower than W₁. Accordingly, the green discharge cells 180b and the blue discharge cells 180c may have larger discharge spaces compared to the red discharge cells 180a, and thus, may have wider area on which phosphor material may be provided.

FIGS. 6A and 6B illustrate cross-sectional views of the vertical barrier ribs 130b taken along lines 6A-6A′, and 6B-6B′, respectively, in FIG. 4. Referring to FIG. 6A, a first vertical barrier rib 130b₁ may include the first barrier rib layer 200a and the second barrier rib layer 220a. The first barrier rib layer 200a may have a first etching speed and the second barrier rib layer 220a may have a second etching speed, which may be slower than the first etching speed, with respect to a predetermined etching solution on both sides of the center axis C of the first vertical barrier rib 130b₁. The first barrier rib layer 200a may correspond to the second barrier rib layer 220a. The first barrier rib layer 200a may have a different curvature than the second barrier rib layer 220a, which may be due to the different etching speeds described above. Thus, the first vertical barrier rib 130b₁ may be asymmetric with respect to a center axis C thereof. Referring to FIG. 6B, a second vertical barrier rib 130b₂ may include the first barrier rib layer 200a, and may be symmetrically formed with respect to the center axis C of the second vertical barrier rib 130b₂.

The first vertical barrier rib 130b₁ may define a boundary between the red discharge cells 180a and the green discharge cells 180b. The first vertical barrier rib 130b, may be wider in a direction towards the red discharge cells 180a. The second vertical barrier rib 130b₂ may define a boundary between the green discharge cells 180b and the blue discharge cells 180c. Accordingly, the green discharge cells 180b and the blue discharge cells 180c may have relatively larger discharge spaces compared to the red discharge cells 180a, and thus, may have a larger area in which phosphor material may be provided.

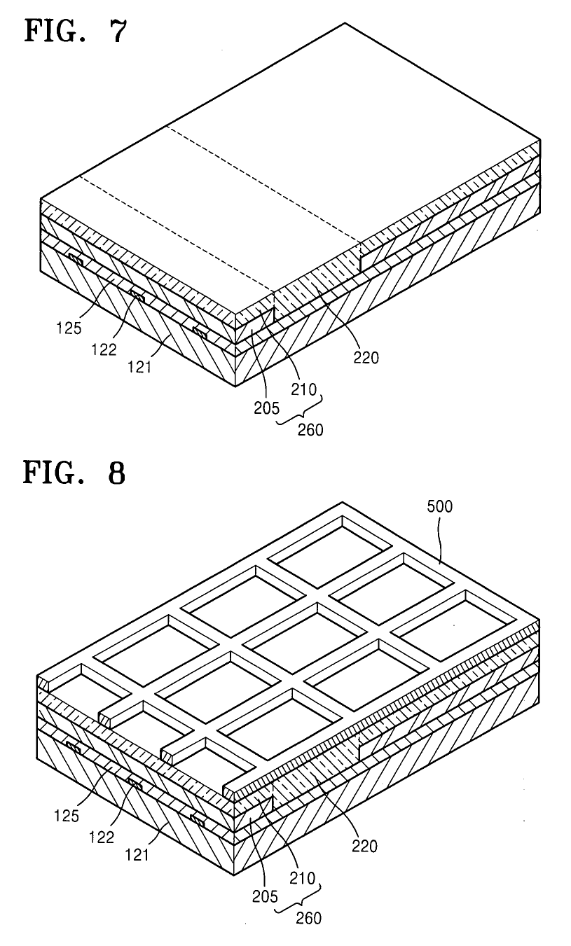

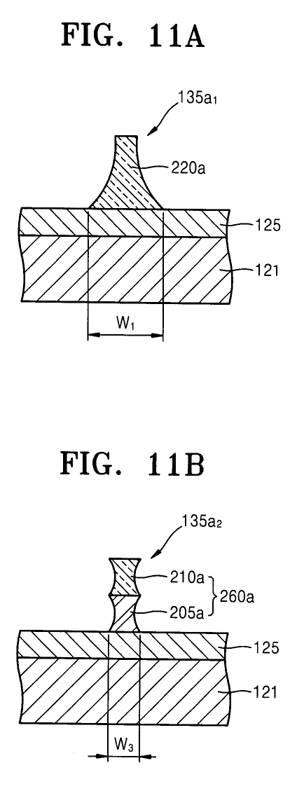

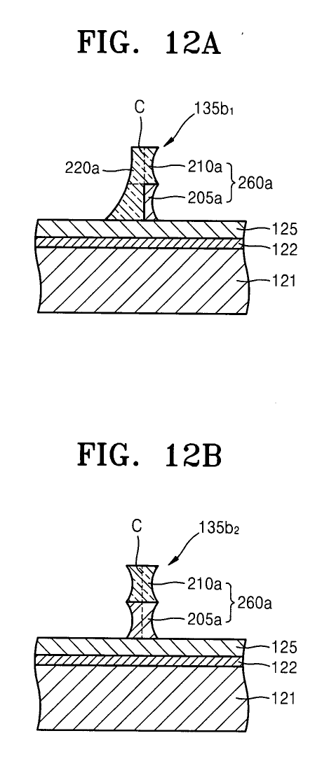

FIGS. 7 through 10 illustrate perspective views of stages in a method of manufacturing barrier ribs according to an embodiment, and FIGS. 11A through 12B illustrate cross-sectional views of a barrier rib illustrated in FIG. 10.

Referring to FIG. 7, a first barrier rib layer 205, the second barrier rib layer 220 and a third barrier rib layer 210 may be on a rear substrate 121, which may include address electrodes 122 and a lower dielectric layer 125. More specifically, a multiple barrier rib layer 260 may include both the first barrier rib layer 205 and the third barrier rib layer 210. The multiple barrier rib layer 260 may be on the rear substrate 121 where green discharge cells 180b and blue discharge cells 180c are to be formed. The second barrier rib layer 220 may be a single layer on the rear substrate 121 corresponding to where red discharge cells 180a are to be formed, as in the previous embodiment. The first and third barrier rib layers 205, 210 may respectively be made of the same materials discussed above in connection with the first and second barrier rib layers 200, 220 of the previous embodiment. Further, as shown in FIG. 7, the second and third barrier rib layers may form a continuous layer, but the present invention is not limited thereto.

In the present exemplary embodiment, the multiple barrier rib layer 260 is a double layer, but the present invention is not limited thereto. The multiple barrier rib layer 260 may include multiple layers in which a lower layer may include a material that has an etching speed that may be faster than a material used for an upper layer.

The multiple barrier rib layer 260 and the second barrier rib layer 220 may be formed by, e.g., a lamination method or by coating and firing a paste composition or a slurry, as described with reference to FIG. 1.

Referring to FIG. 8, the etch mask layer 500 may be formed on the multiple barrier rib layer 260 and the second barrier rib layer 220. The etch mask layer 500, as described with reference to FIG. 2, may be formed so as to expose portions of the multiple barrier rib layer 260 and the second barrier rib layer 220 where discharge cells are to be formed. A photoresist layer (not shown) may be exposed and developed to define the location of the discharge cells.

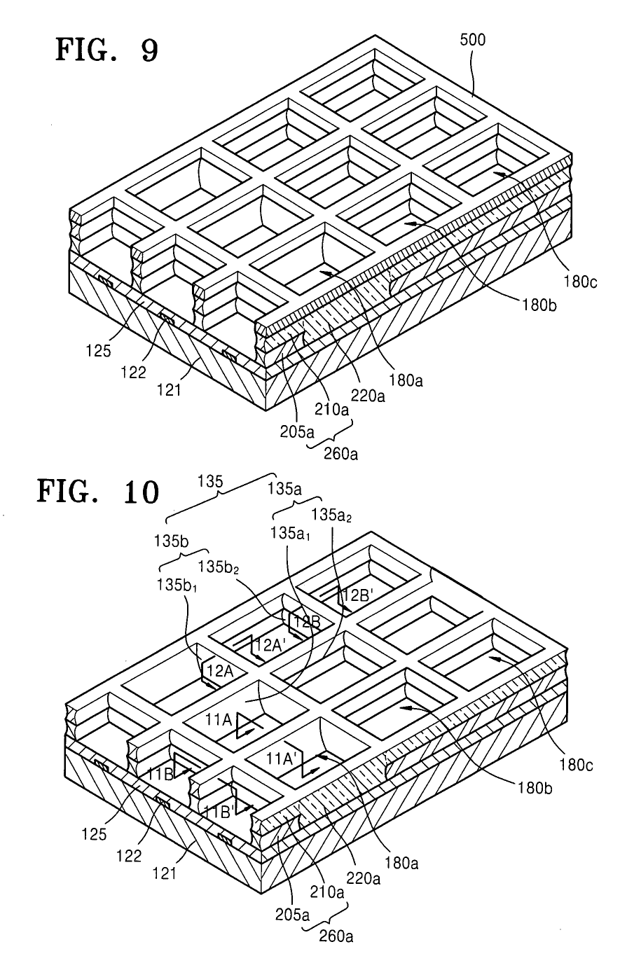

Referring to FIG. 9, discharge cells 180a, 180b, and 180c may be formed by etching the multiple barrier rib layer 260 and the second barrier rib layer 220 using the etch mask layer 500. The etching method may be, e.g., a chemical etching method. An etching solution may penetrate the multiple barrier rib layer 260 at a first etching speed through the first barrier rib layer 205, and the second and third barrier rib layers 220, 210 may be etched at a second speed, which may be slower than the first etching speed. Accordingly, two curves may be formed on the sidewalls of the multiple barrier rib layer 260a. Thus, the sidewalls of the multiple barrier rib layer 260a may have a certain degree of linearity, i.e., may be less sloped, than the second barrier rib layer 220a alone.

The etching processes may be performed simultaneously on the multiple barrier rib layer 260a using the same mask and etching solution. The first barrier rib layer 205a and the third barrier rib layer 210a may border each other, and may have different etching speeds. The first barrier rib layer 205a and the third barrier rib layer 210a may be simultaneously exposed. Neither the first barrier rib layer 205a nor the third barrier rib layer 210a may act as an etch stop film, but the etching process may be performed at different etching speeds. Therefore, the boundary between the first barrier rib layer 205a and the third barrier rib layer 210a may be relatively smooth.

The multiple barrier rib layer 260a may have at least two curves on the sidewall. Therefore, the multiple barrier rib layer 260a may have a sidewall surface that is larger than that of the second barrier rib layer 220a.

When the etch mask layer 500 is removed, barrier ribs 135 may be as depicted in FIG. 10. The barrier ribs 135 may be in a matrix shape and, accordingly, may include a plurality of horizontal barrier ribs 135a and a plurality of vertical barrier ribs 135b.

The horizontal barrier ribs 135a may include first horizontal barrier ribs 135a₁ and second horizontal barrier ribs 135a₂, and the vertical barrier ribs 135b may include first vertical barrier ribs 135b₁ and second vertical barrier ribs 135b₂.

FIG. 11A illustrates a cross-sectional view of the first horizontal barrier ribs 135a₁ taken along line 11A-11A′ in FIG. 10. The first horizontal barrier ribs 135a₁ may be formed on the second barrier rib layer 220a, which may have a relatively slow second etching speed. The first horizontal barrier ribs 135a₁ may be symmetric with respect to the center axis C of the first horizontal barrier ribs 135a₁, and may have the relatively wide lower width W₁, i.e., may be the same as the first horizontal barrier rib 130a₁ illustrated in FIG. 5A.

FIG. 11B illustrates a cross-sectional view of the second horizontal barrier ribs 135a₂ taken along line 11B-11B′ in FIG. 10. The second horizontal barrier ribs 135a₂ may include the first barrier rib layer 205a and the third barrier rib layer 210a formed on the first barrier rib layer 205a. The first barrier rib layer 205a may have a relatively high first etching speed, thus multiple barrier rib layer 260a may have a lower width W₃ narrower than the width W₁. Red discharge cells 180a defined by the wider first horizontal barrier ribs 135a₁ may be smaller than green discharge cells 180b or blue discharge cells 180c defined by the narrower second horizontal barrier ribs 135a₂.

FIG. 12A illustrates a cross-sectional view of the first vertical barrier ribs 135b₁ taken along line 12A-12A′ in FIG. 10. The first vertical barrier ribs 135b₁ may be asymmetric about the center axis C. In this exemplary embodiment, the first vertical barrier ribs 135b₁ may extend further in a direction towards the red discharge cells 180a, and thus, the discharge spaces of the red discharge cells 180a may be relatively small.

FIG. 12B illustrates a cross-sectional view of the second vertical barrier ribs 135b₁ taken along line 12B-12B′ in FIG. 10. The second vertical barrier ribs 135b₂ may include the multiple barrier rib layer 260a and may be symmetric with respect to the center axis C.

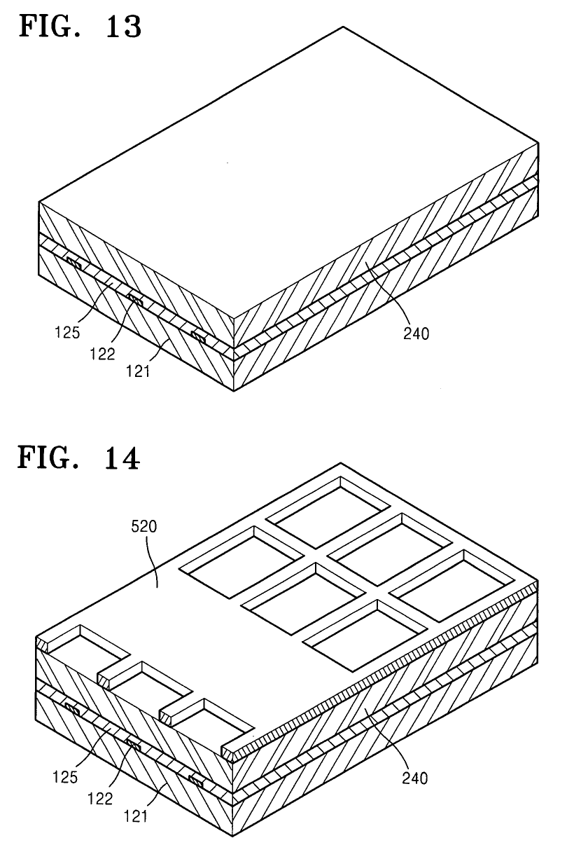

FIGS. 13 through 17 illustrate perspective views of stages in a method of manufacturing barrier ribs according to an embodiment.

Referring to FIG. 13, a barrier rib layer 240 may be formed on the rear substrate 121 on which address electrodes 122 and the lower dielectric layer 125 may be formed. As described above for FIG. 1, the barrier rib layer 240 may be formed using a lamination method or by coating and firing a paste composition or a slurry, but the present invention is not limited thereto.

Referring to FIG. 14, a first etch mask layer 520 may be formed on the barrier rib layer 240. The first etch mask layer 520 may expose a predetermined region of the barrier rib layer 240 where green discharge cells 180b and blue discharge cells 180c are to be formed. The first etch mask layer 520 may be patterned through exposing and developing processes.

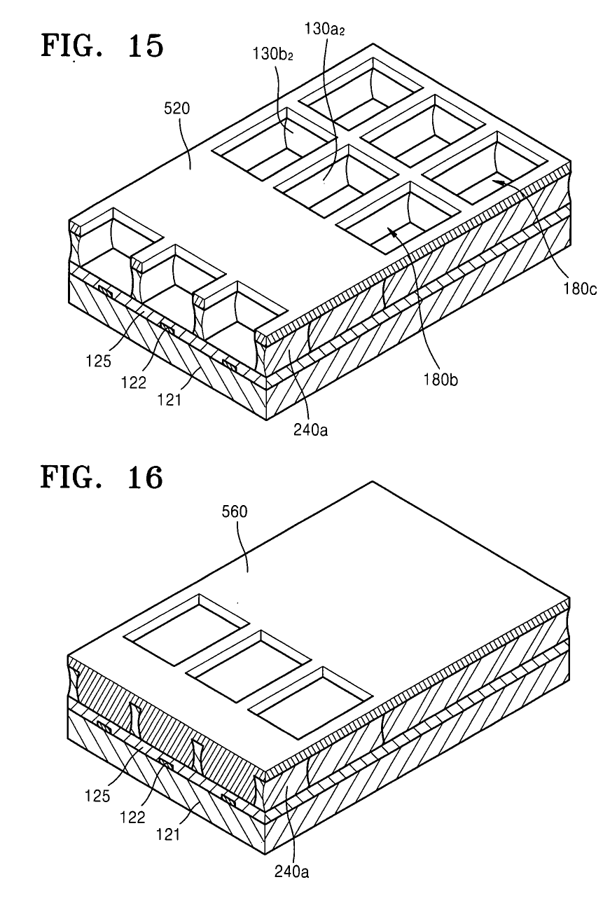

Referring to FIG. 15, an etching process may be performed by spraying a first etching solution on the resultant product of FIG. 14 using the first etch mask layer 520 as an etch mask. The first etching solution may have a first etching speed with respect to the barrier rib layer 240. Therefore, a barrier rib layer 240a formed by the etching process may have a bottleneck shape with a relatively narrow lower width. The green discharge cells 180b and the blue discharge cells 180c may be defined by such a barrier rib layer 240a.

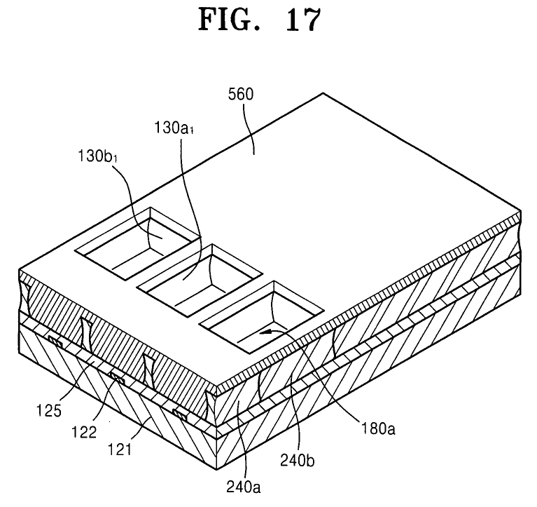

Referring to FIG. 16, the first etch mask layer 520 may be removed and a second etch mask layer 560 may be formed on the barrier rib layer 240a to expose a predetermined region of the barrier rib layer 240a where the red discharge cells are to be formed. The second etch mask layer 560 may be formed so as to cover the green discharge cells 180b and the blue discharge cells 180c, so that the green discharge cells 180b and the blue discharge cells 180c may not be further etched.

Referring to FIG. 17, a second etching solution may be sprayed onto the barrier rib layer 240a so that it may be etched according to the second etch mask layer 560. The second etching solution may have a second etching speed, which may be slower than the first etching speed, with respect to the etching process performed on barrier rib layer 240a. Therefore, a barrier rib layer 240b may have a lower width which may be wider than the lower width of the barrier rib layer 240a formed by the etching process described with reference to FIG. 16.

The second etch mask layer 560 may be removed to complete the manufacturing of the barrier rib. The barrier rib formed in the present embodiment may have the same shape as depicted in FIGS. 4 through 6B, although the barrier ribs of this embodiment may be of a single material.

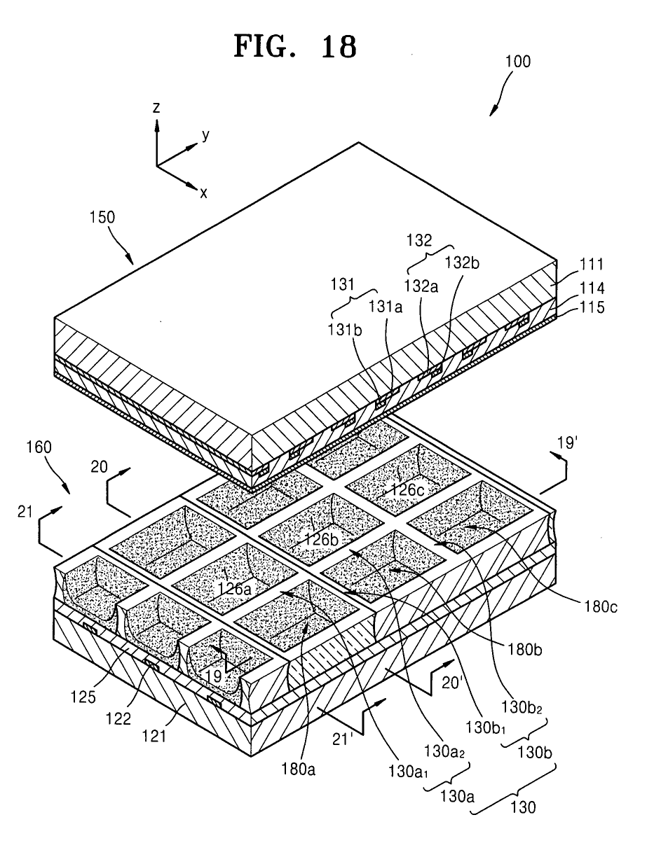

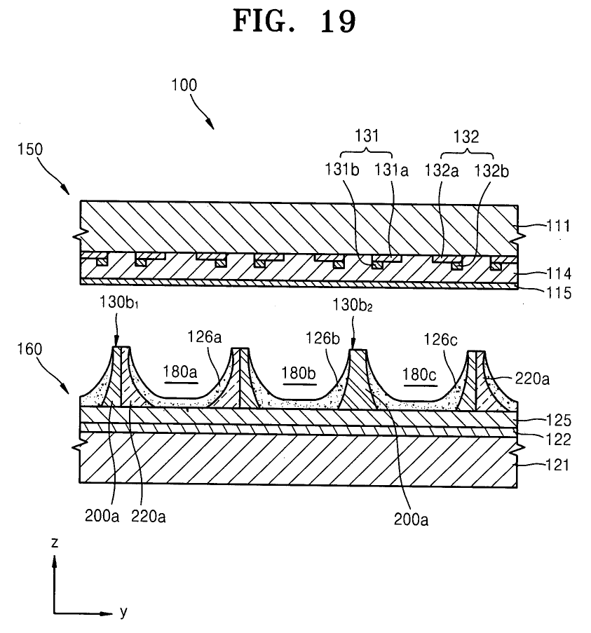

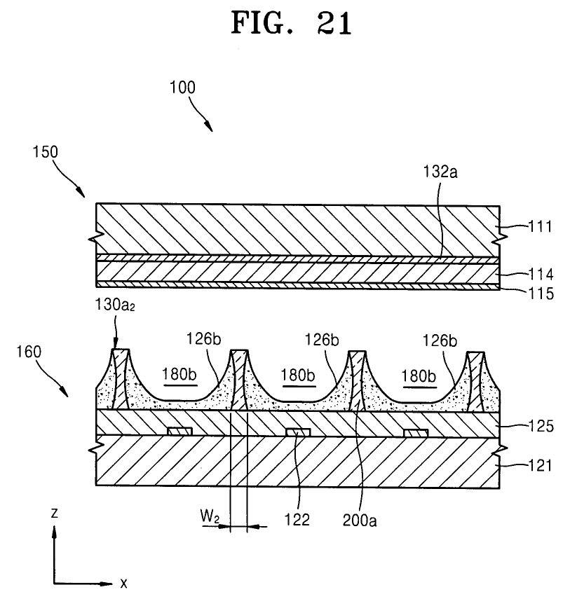

FIG. 18 illustrates an exploded perspective view of a plasma display panel (PDP) according to an embodiment. FIGS. 19 and 21 illustrate cross-sectional views of the PDP illustrated in FIG. 18.

Referring to FIG. 18, a PDP 100 may include a front panel 150 and a rear panel 160 that may be combined facing each other. The front panel 150 may include a front substrate 111, sustain electrode pairs 131, 132, an upper dielectric layer 114, and a passivation layer 115. The rear panel 160 may include the rear substrate 121, address electrodes 122, the lower dielectric layer 125, barrier ribs 130, and phosphor layers 126a, 126b, and 126c.

The front substrate 111 and the rear substrate 121 may be a predetermined distance apart from each other and may face each other so as to define a discharge space where plasma discharge may occur. The front substrate 111 and the rear substrate 121 may be, e.g., glass having high visible light transmittance or colored to improve bright room contrast.

The barrier ribs 130 may be between the front substrate 111 and the rear substrate 121, and more specifically, the barrier ribs 130 may be formed on the lower dielectric layer 125. The barrier ribs 130 may define the discharge space for a plurality of discharge cells 180a, 180b, and 180c, and may prevent optical and electrical cross-talk between the discharge cells 180a, 180b, and 180c.

Referring to FIG. 18, the barrier ribs 130 may include horizontal barrier ribs 130a that may extend in the same direction (y direction) as the address electrodes 122 and vertical barrier ribs 130b that may interconnect the horizontal barrier ribs 130a.

The horizontal barrier ribs 130a may include first horizontal barrier ribs 130a₁ and second horizontal barrier ribs 130a₂, and the vertical barrier ribs 130b may include first vertical barrier ribs 130b₁ and second vertical barrier ribs 130b₂.

FIG. 19 illustrates a cross-sectional view of the PDP 100 taken along line 19-19′ in the Y direction in FIG. 18. Referring to FIG. 19, the first vertical barrier rib 130b₁ may include the first barrier rib layer 200a and the second barrier rib layer 220a which may be adjacent to each other. The second barrier rib layer 220a may have an etching speed slower than that of the first barrier rib layer 200a. Therefore, a lower width of the second barrier rib layer 220a, adjacent the red discharge cells 180a, may be wider than the lower width of the first barrier rib layer 200a, adjacent the blue discharge cells 180c or green discharge cells 180b. Accordingly, the discharge spaces of the red discharge cells 180a may be smaller than the discharge spaces of the other discharge cells. Accordingly, the areas on which red phosphor material may be provided may be reduced. The second vertical barrier ribs 130b₂ may be formed from the first barrier rib layer 200a and may have a symmetrical thin bottleneck shape.

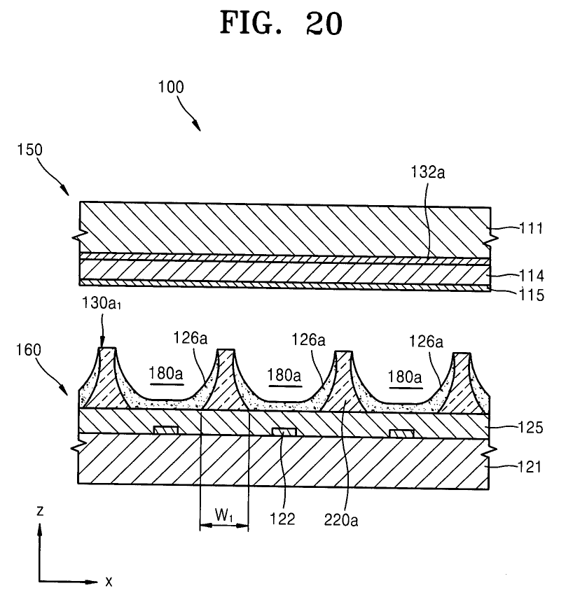

FIGS. 20 and 21 illustrate cross-sectional views of the PDP 100 taken along lines 20-20′ and 21-21′, respectively, in the X direction in FIG. 18. Referring to FIGS. 20 and 21, the first horizontal barrier ribs 130a₁ may be formed from the second barrier rib layer 220a and the second horizontal barrier ribs 130a₂ may be formed from the first barrier rib layer 200a. The first horizontal barrier ribs 130a₁ may have a relatively slow etching speed, and the second horizontal barrier ribs 130a₂ may having a relatively fast etching speed. Therefore, a lower width W₁ of the first horizontal barrier ribs 130a₁ may be wider than the lower width W₂ of the second horizontal barrier ribs 130a₂. The first and second horizontal barrier ribs 130a₁ and 130a₂ may be formed asymmetrically as compared to each other; however, each of the first and second horizontal barrier ribs 130a₁ and 130a₂ may be symmetric with respect to the center axis thereof.

In FIG. 18, the barrier ribs 130 may define the discharge cells 180a, 180b, and 180c as a matrix having a rectangular shaped horizontal cross-section, but the present invention is not limited thereto. That is, the barrier ribs 130 may define the discharge cells 180a, 180b, and 180c to have various closed shapes, e.g., polygonal, such as triangular or pentagonal, circular or oval, or various open shapes, e.g., a stripe. Additionally, the barrier ribs 130 may define the discharge cells 180a, 180b, and 180c in a delta shaped arrangement.

Referring again to FIG. 18, the sustain electrode pairs 131, 132 may be on the front substrate 111 that may face the rear substrate 121. The sustain electrode pairs 131, 132 may be parallel to each other on the front substrate 111. Each of the sustain electrode pairs 131, 132 may include an X electrode 131 that may act as a sustain electrode and a Y electrode 132 that may act as a scanning electrode.

The X and Y electrodes 131 and 132, respectively, may include transparent electrodes 131a and 132a and bus electrodes 131b and 132b. The transparent electrodes 131a and 132a may be formed of a conductive and transparent material that may not block the visible light generated from the phosphor layers 126a, 126b, and 126c, e.g., indium tin oxide (ITO). However, such conductors may have high electrical resistance. When a discharge electrode may be formed using only the transparent electrode, power consumption may increase and response time may be long due to the large voltage drop along the electrode. To avoid the above problems, narrow bus electrodes 131b and 132b may be formed of a metal having a high conductivity, and may be on the transparent electrodes 131a and 132a. The transparent electrodes 131a and 132a and the bus electrodes 131b and 132b may be formed through, e.g., a photo etching method or a photolithography method.

The shape and dispositions of the X and Y electrodes 131 and 132 will now be described. The bus electrodes 131b and 132b may be a predetermined distance apart from each other, may be parallel to each other in unit discharge cells 180, and may extend across the discharge cells 180. As described above, the transparent electrodes 131a and 132a may be respectively electrically connected to the bus electrodes 131b and 132b. However, the rectangular-shaped transparent electrodes 131a and 132a may be discontinuous in each of the unit discharge cells 180, whereby the ends of the transparent electrodes 131a and 132a may be respectively connected to the bus electrodes 131b and 132b, and the other ends of the transparent electrodes 131a and 132a may be respectively oriented to face central portions of the discharge cells 180a, 180b, and 180c.

The upper dielectric layer 114 may bury the sustain electrode pairs 131, 132 and may be formed on the front substrate 111. The upper dielectric layer 114 may not only prevent electrical connection between adjacent X electrodes 131 and the Y electrodes 132, but may also prevent the X and Y electrodes 131 and 132 from being damaged due to direct collisions with charged particles and electrons. The upper dielectric layer 114 may be formed from a variety of materials, e.g., PbO, B₂O₃, or SiO₂.

The PDP 100 may further include the passivation layer 115 on the upper dielectric layer 114. The passivation layer 115 may prevent the upper dielectric layer 114 from being damaged due to collisions with charged particles and electrons during discharges. The passivation layer 115 may be formed by, e.g., sputtering or electron beam deposition of a material that may have a high secondary electron emission coefficient and a high visible light reflectance.

The address electrodes 122 may be formed on the rear substrate 121 that may face the front substrate 111. The address electrodes 122 may extend across the unit discharge cells and cross the X and Y electrodes 131 and 132. The address electrodes 122 may generate an address discharge that may facilitate sustain discharges between the X and Y electrodes 131 and 132. More specifically, the address electrodes 122 may reduce a voltage that may cause the sustain discharge. The address discharge may occur between the Y electrode 132 and the address electrodes 122.

The lower dielectric layer 125 may bury the address electrodes 122, and may be formed between the rear substrate 121 and the barrier ribs 130. The lower dielectric layer 125 may be formed of a dielectric material, e.g., PbO, B₂O₃, or SiO₂, that may prevent the address electrodes 122 from being damaged due to collisions with charged particles or electrons and can induce charges.

The red, green, and blue phosphor layers 126a, 126b, and 126c may be on both side surfaces of the barrier ribs 130 formed on the lower dielectric layer 125 and may be on the entire surface of the lower dielectric layer 125 where the barrier ribs 130 may not be formed. The phosphor layers 126a, 126b, and 126c may include components that generate visible light in response to receiving vacuum ultraviolet (VUV) light. The red discharge cell 180a may include the phosphor layer 126a, e.g., Y(V, P)O₄:Eu, the green discharge cell 180b may include the phosphor layer 126b, e.g., Zn₂SiO₄:Mn or YBO₃:Tb, and the blue discharge cell 180c may include the phosphor layer 126c, e.g., BAM:Eu.

A discharge gas mixture, e.g., Ne gas and/or Xe gas, may fill the discharge cells 180a, 180b, and 180c. The front and the rear substrates 111 and 121 may then be attached to each other using a sealing member (not shown), e.g., frit glass, on edges of the front and the rear substrates 111 and 121, and may seal the discharge gas mixture inside.

Operation of the PDP 100 depicted in FIG. 18 will now be described. Plasma discharge that may occur in the PDP 100 may be broadly divided into an address discharge and a sustain discharge. The address discharge may be generated between the address electrodes 122 and the Y electrodes 132 by an address discharge voltage applied between the address electrodes 122 and the Y electrodes 132. As a result of the address discharge, unit discharge cells 180, in which sustain discharge is to be generated, may be selected. Thereafter, when a sustain pulse voltage is applied between the X and Y electrodes 131 and 132 of the selected unit discharge cells 180, sustain discharge may be generated in the unit discharge cells 180. During the sustain discharge, since electrons generated from the upper dielectric layer 114 may be supplied to the unit discharge cells 180 and secondary electrons may be generated from the passivation layer 115, the sustain discharge may be further actively generated. The discharge gas may be excited during the sustain discharge and may emit VUV light as the energy level of the discharge gas is reduced. The VUV light may excite the phosphor materials 126 in the unit discharge cells 180. Visible light may be emitted from the phosphor materials as the energy level of the phosphor materials is reduced. The visible light may be emitted through the front substrate 111, and thus images may be displayed.

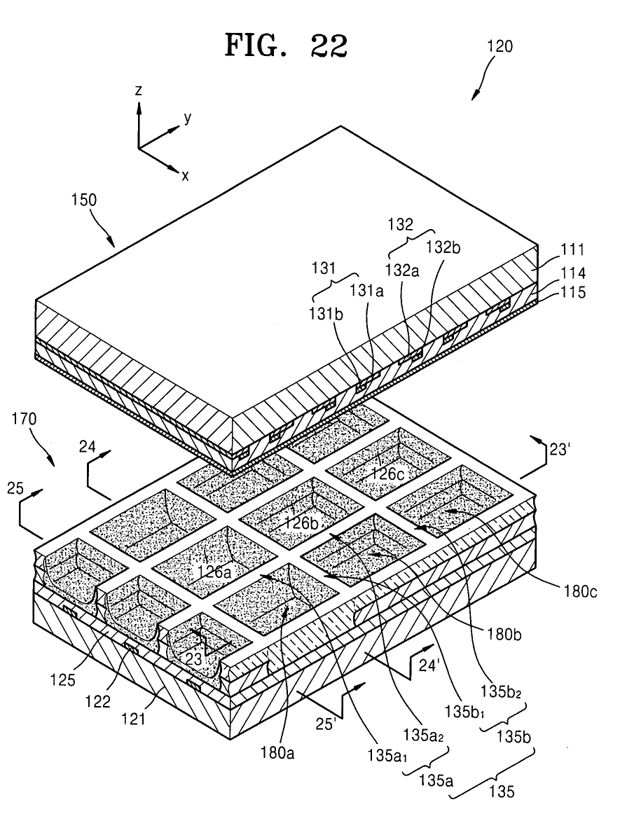

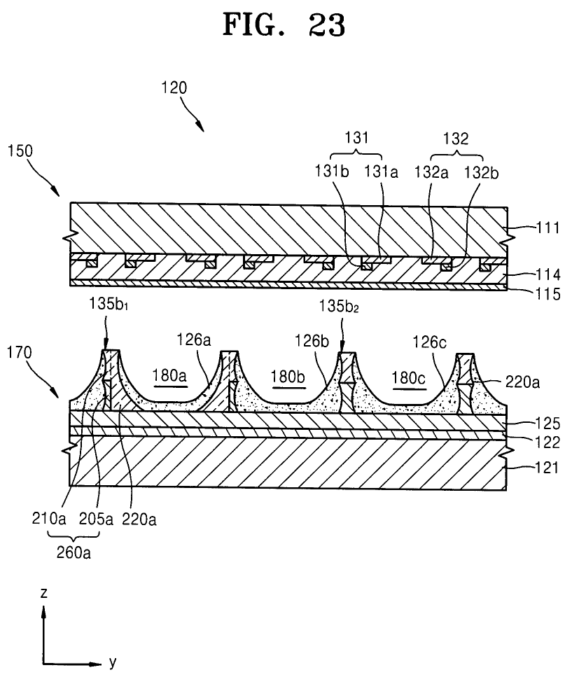

FIG. 22 illustrates an exploded perspective view of a PDP 120 according to an embodiment. FIGS. 23 through 25 illustrate cross-sectional views of the plasma display panel illustrated in FIG. 22, taken along lines 23-23′; 24-24′; and 25-25′, respectively.

The PDP 120 depicted in FIG. 22 may be similar to the PDP 100 in FIG. 18, and accordingly, common elements and the method of operation may be the same as described with reference to FIGS. 18 through 21. Thus, hereinafter, differences between the PDP 120 illustrated in FIG. 22 and the PDP 100 in FIG. 18 will now be described in detail.

Referring to FIG. 22, a rear panel 170 may include address electrodes 122 and a lower dielectric layer 125. Barrier ribs 135 may be formed on the rear substrate 121 which may include the address electrodes 122 and the lower dielectric layer 125.

The barrier ribs 135 may include a plurality of horizontal barrier ribs 135a and a plurality of vertical barrier ribs 135b. Each of the horizontal barrier ribs 135a may include a first horizontal barrier rib 135a₁ which may be formed from a single barrier rib layer and a second barrier rib 135a₂ which may be formed from a multiple barrier rib layer. Each of the vertical barrier ribs 135b may include a first vertical barrier rib 135b₁, which may be asymmetric with respect to the center axis of the first vertical barrier ribs 135b₁, and a second vertical barrier rib 135b₂.

FIG. 23 illustrates a cross-sectional view taken along line 23-23′ in a Y direction of the plasma display panel 120 illustrated in FIG. 22. Referring to FIG. 23, the first vertical barrier rib 135b₁ may have an asymmetrical structure which may include the multiple barrier rib layer 260a. The multiple barrier rib layer 260a may include the first barrier rib layer 205a, that may have a relatively faster etching speed, and the third barrier rib layer 210a formed on the first barrier rib layer 205a. The multiple barrier rib layer 260a and the second barrier rib layer 220a may be formed on adjacent sides of the first vertical barrier rib 135b₁ with respect to the center axis thereof. The lower part of the multiple barrier rib layer 260a may be formed from the first barrier rib layer 205a that may have a relatively fast etching speed, i.e., faster than the second or third barrier rib layers 220a, 210a. Thus, the etching of the lower part of the multiple barrier rib layer 260a may be performed relatively quickly.

Accordingly, the multiple barrier rib layer 260a may have a more linear configuration than the adjoining second barrier rib layer 220a. Accordingly, discharge spaces of green discharge cells 180b and blue discharge cells 180c, which may be defined by the multiple barrier rib layer 260a, may be relatively large. Thus, areas within those discharge spaces may be relatively wide. A green phosphor material may have a high luminous efficiency. Therefore, the increase in discharge spaces of the green discharge cells 180b and the wider phosphor coating area for the green phosphor material may increase the brightness of the PDP 120. A blue phosphor material may improve the color temperature. Therefore, the increase in discharge spaces for the blue discharge cells 180c and the wider phosphor coating area for the blue phosphor material may improve the color temperature of the PDP 120. The single barrier rib layer 250a may include the second barrier rib layer 220a that may have a relatively slow etching speed. Therefore, the likelihood of an etching solution penetrating into a lower part of the single barrier rib layer 250a may be low, so that etching of the lower part of the single barrier rib layer 250a may not be performed smoothly. Thus, the single barrier rib layer may have a wide lower width toward the red discharge cell 180a. Accordingly, the discharge spaces for the red discharge cells 180a may be relatively reduced, and thus, the areas available to coat the red phosphor material may also be reduced.

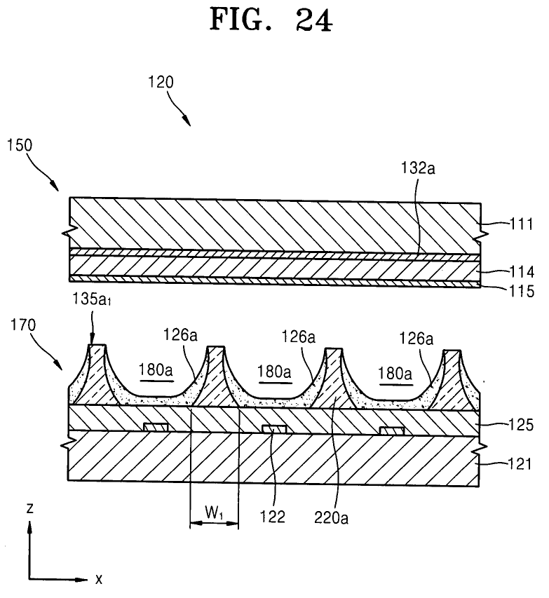

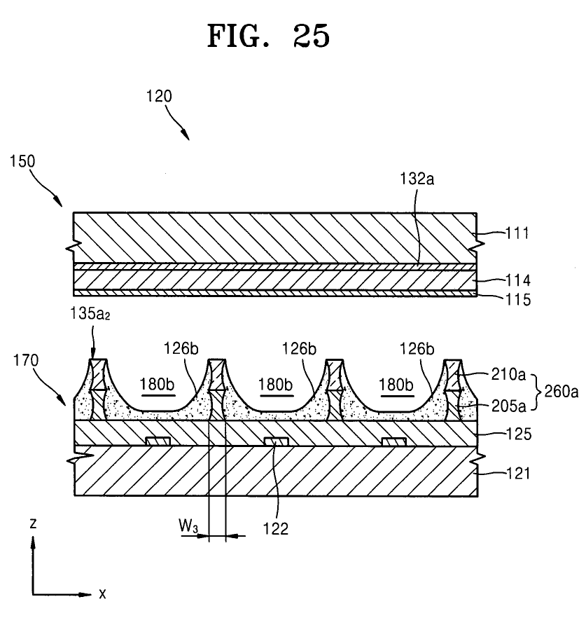

FIGS. 24 and 25 illustrate cross-sectional views taken along lines 24-24′ and 25-25′ in the X direction of the plasma display panel 120 illustrated in FIG. 22. Referring to FIGS. 24 and 25, the first horizontal barrier ribs 135a₁ may include the second barrier rib layer 220a which may have a relatively slow etching speed. Therefore, the lower width W₁ may be relatively wider, and the second barrier rib layer 220a may have a bottle shape. The second horizontal barrier ribs 135a₂ may include a lower width W₃ which may be narrower than the lower width W₁, since the second horizontal barrier ribs 135a₂ may be formed of the multiple barrier rib layer 260a. The second horizontal barrier ribs 135a₂ may have a structure in which at least two curves may be formed on side surfaces thereof.

### COMPARATIVE EXAMPLE

The brightness, luminous efficiency, and color temperature of the PDP 120 depicted in FIG. 22 were observed and recorded. The PDP 120 was compared to a conventional PDP, in which the discharge spaces are identical, i.e., regardless of the phosphor materials to be provided therein, the results of which are shown in Table 1.

TABLE 1

| | Conventional | | | |
|---|---|---|---|---|
| | PDP | PDP 120 | Difference | % Increase |
| Brightness | 174 cd/m2 | 201 cd/m2 | 27 cd/m2 | 15.5% |
| Luminous efficiency | 1.07 lu/w | 1.17 lu/w | 0.10 lu/w | 9.34% |
| Color temperature | 8500 | 9650 | 1150 | 13.5% |

As shown in Table 1, the PDP 120 according to an embodiment showed improvements of about 15.5% brightness, about 9.34% luminous efficiency, and about 13.5% color temperature over the conventional PDP.

By using etching to form barrier ribs of a PDP, opening failures of the barrier ribs may be reduced. Further, according to embodiments, at least one of the barrier ribs of the barrier rib structure may be asymmetric about a center axis thereof, e.g., by etching the barrier ribs from a plurality of barrier rib layers and/or using a multiple etching steps. Thus, the thickness of the barrier ribs and/or the surface area over which phosphor material may be provided may differ for each discharge cell or discharge cell type.

In a PDP according to embodiments, the thickness and/or surface area of the barrier ribs may be controlled for each discharge cell, thereby allowing different discharge cells to have different amounts of phosphor material therein. Thus, discharge cells for those phosphor materials contributing to an increased brightness and luminous efficiency or to color temperature improvement may be larger, allowing more phosphor material to be provided therein, thereby increasing brightness and luminous efficiency and improving the color temperature of the PDP.

Exemplary embodiments of the present invention have been disclosed herein, and although specific terms are employed, they are used and are to be interpreted in a generic and descriptive sense only and not for purpose of limitation. For example, while only two different discharge cell configurations are illustrated in the above embodiments, it will be understood by those of ordinary skill in the art that the method of making the barrier ribs may be controlled to realize three or more different discharge cell configurations. Accordingly, it will be understood by those of ordinary skill in the art that various changes in form and details may be made without departing from the spirit and scope of the present invention as set forth in the following claims.

What is claimed is:

1. A method of forming barrier ribs of a plasma display panel, comprising:
providing a barrier rib layer on a substrate; and
selectively removing portions of the barrier rib layer to form a barrier rib structure defining a plurality of first and second discharge cells, at least one barrier rib of the barrier rib structure having a horizontal cross-section that is asymmetric along a center axis thereof, the first and second discharge cells having different internal surface areas.

2. The method as claimed in claim 1, wherein:
providing the barrier rib layer includes forming a first barrier rib layer and a second barrier rib layer on the substrate, the first and second barrier rib layers being adjacent on the substrate and having different etch speeds; and
selectively removing includes
providing an etch mask to expose a predetermined region of the first barrier rib layer and a predetermined region of the second barrier rib layer, and
etching the exposed predetermined regions of the first and second barrier rib layers using the etch mask.

3. The method as claimed in claim 2, wherein the first barrier rib layer has a first etching speed with respect to an etching solution, and the second barrier rib layer has a second etching speed, which is slower than the first etching speed, with respect to the etching solution.

4. The method as claimed in claim 2, wherein forming the first barrier rib layer and the second barrier rib layer comprises:
providing the first barrier rib layer on the substrate where the first discharge cells are to be formed; and
providing the second barrier rib layer on the substrate where the second discharge cells are to be formed.

5. The method as claimed in claim 4, wherein forming the first barrier rib layer further comprises providing a third barrier rib layer on the first barrier rib layer.

6. The method as claimed in claim 1, wherein the first and second discharge cells are to be provided with different phosphor materials.

7. The method as claimed in claim 6, wherein the different phosphor materials produce different colors.

8. The method as claimed in claim 1, wherein there are twice as many first discharge cells as second discharge cells, and the at least one barrier rib is between one of the first discharge cells and one of the second discharge cells.

9. The method as claimed in claim 1, wherein the at least one barrier rib defines adjacent discharge cells having different widths.

10. The method as claimed in claim 1, wherein an internal surface area of the first discharge cells is greater than that of the second discharge cells.

11. The method as claimed in claim 1, wherein selectively removing includes:
providing a first etch mask on the barrier rib layer to expose a first predetermined region of the barrier rib layer where the first discharge cells are to be formed;
etching the exposed barrier rib layer using a first etching solution that has a first etching speed with respect to the barrier rib layer;
providing a second etch mask on the barrier rib layer to expose a second predetermined region of the barrier rib layer where the second discharge cells are to be formed;
etching the exposed barrier rib layer using a second etching solution that has a second etching speed, which is different from the first etching speed, with respect to the barrier rib layer.

12. The method as claimed in claim 11, wherein the second etching speed is slower than the first etching speed.

13. A plasma display panel, comprising:
a rear substrate;
a front substrate a predetermined distance apart from the rear substrate; and
a barrier rib structure between the front and rear substrates, the barrier rib structure defining a plurality of first and second discharge cells, at least one barrier rib of the barrier rib structure having a horizontal cross-section that is asymmetric along a center axis thereof, the first and second discharge cells having different internal surface areas.

14. The plasma display panel as claimed in claim 13, wherein the at least one barrier rib includes a first material on the substrate and a second material on the substrate, the second material abutting the first material, a first sidewall of the first material having a different slope than a second sidewall of the second material.

15. The plasma display panel as claimed in claim 14, wherein the at least one barrier rib further includes a third material on the first material, the second material abutting the third material.

16. The plasma display panel as claimed in claim 15, wherein the second and third materials are the same.

17. The plasma display panel as claimed in claim 15, wherein a third sidewall of the third material has a different slope than the first sidewall.

18. The plasma display panel as claimed in claim 13, wherein the at least one barrier rib is made of a single material.

19. The plasma display panel as claimed in claim 13, further comprising:
a first phosphor material in the first discharge cells; and
a second phosphor material in the second discharge cells, the second phosphor material being different from the first phosphor material.

20. The plasma display panel as claimed in claim 19, wherein the first and second phosphor materials produce different colors.

21. The plasma display panel as claimed in claim 13, wherein there are twice as many first discharge cells as second discharge cells, and the at least one barrier rib is between one of the first discharge cells and one of the second discharge cells.
